(19) United States
(12) Patent Application Publication
(10) Pub. No.: US 2025/0283446 A1
(43) Pub. Date: Sep. 11, 2025

(54) WAVE-POWERED ELECTRIC GENERATOR

(71) Applicant: Thomas Mitchell Rock, Cockeysville, MD (US)

(72) Inventor: Thomas Mitchell Rock, Cockeysville, MD (US)

(21) Appl. No.: 18/601,606

(22) Filed: Mar. 11, 2024

(51) Int. Cl. F03B 13/14; H02K 7/02; H02K 7/116; H02K 7/18

(52) U.S. Cl. CPC F03B 13/186; F03B 13/14; H02K 7/02; H02K 7/116; H02K 7/1853; F05B 2220/706; F05B 2260/4031

(57) ABSTRACT

A rapidly deployable, ecological, floating, electrical generation device which uses a buoyancy-controlled piston including a rack and pinion system to drive a rotating shaft which is coupled to a floating power generation system. As the floating power generation system rises and falls with the motion of ocean waves, the buoyancy-controlled piston maintains its position in the water. As the relative positions between the floating power station and the buoyancy-controlled piston change, the rack and pinion system drives the rotating shaft. A series of gears increases the rotational speed to spin a shaft and flywheel at moderate speed. Another set of gears are then used to increase rotational speed and drive the shaft of a dynamo which produces electrical current by spinning an electromagnet with a coil. The result is environmentally sourced electrical energy that can be used, stored and/or transmitted in any conventional fashion.

### BACKGROUND OF THE INVENTION

### Field of the Invention

The present application relates to devices and methods for using ocean wave action to generate electricity.

### Background of the Invention

As energy usage increases, fossil fuel sources are being depleted, and environmental concerns abound, the need for clean renewable energy necessitates the generation of power from environmental sources. One abundant but essentially untapped resource is that of oceanic waves. Accessing the wave energy from portions of the United States' 90,000 mile coastline will allow for the clean generation of large quantities of electricity, virtually forever. Doing so with readily available materials allows for a more promising energy outlook. Energy independence and sustainability promote greater national independence and a reliable economy. Clean energy is a requisite for a healthy environment.

### SUMMARY OF THE INVENTION

The present invention presents a solution to the need for clean and renewable energy that takes advantage of the constant rise and fall of ocean waves. The device of the present invention features two main parts. The first part is an electrical generation station mounted on a floating structure. The floating structure may be a buoy, a boat, or any other kind of partially or entirely floating structure. The generation of electricity takes place in the standard manner of spinning a magnet inside a coil.

The second part of the device is a buoyancy-controlled piston configured to maintain a relatively constant vertical position in the ocean (at least relative to the floating structure portion of the device), notwithstanding the motion of the waves. As the floating structure rises and falls with the waves, the buoyancy-controlled piston maintains a relatively constant position in the water, and a gear rack on the piston moves up and down, driving a rotating shaft with every down stroke via a ratcheting device and pinion gear.

More specifically, the buoyancy-controlled piston is attached to the electricity generation station on the floating structure by a gear rack with pinion gear system in which the pinion gear is made to rotate in only one direction through the use of an anti-reverse bearing or similar device. At the top of the piston, a gear rack is solidly affixed within a frame. On the floating structure, a pinion gear is connected to a rotating shaft with an anti-reverse bearing device which causes the pinion to engage the rotating shaft and drive rotation during the downstroke phase of the piston's motion, but permits the pinion gear to spin freely along the shaft when spinning in the opposite direction of the rotating shaft during the upstroke phase—essentially using a ratcheting type of motion. As the pinion travels along the gear rack, energy from the vertical motion of the gear rack (which is affixed to the piston) is transmitted into rotational energy by the pinion gear. The energy is then transmitted from the pinion gear to the rotating drive shaft of the electrical generation station on the floating structure via an anti-reverse bearing device/mechanism (i.e., ratchet, sprag bearing, roller clutch, etc.).

In this way the device functions in the opposite manner of a standard piston type motor, because in this case the piston is essentially stationary while the machinery which generates the energy is in motion. This vertical motion of the buoy versus the relatively stationary piston causes the gear rack on the piston to move up and down, driving the rotating shaft with every down stroke. The spinning shaft transmits its energy via a series of gears or pulleys to spin a flywheel. The momentum of the flywheel is transmitted to a dynamo which, in turn, produces the electricity.

A key feature of the invention is the way that the piston is kept relatively stationary in the ocean, relative to the electricity generation station-bearing floating structure. According to a first aspect, the piston may feature a plurality of chambers that are filled with air and/or water according to the density of the water in order to give the piston a neutral buoyancy in the particular body of water. According to a second aspect, the piston is provided with a plurality of resistance buckets configured to alternately resist the upward force of the buoy as the buoy is lifted by the crest of each ocean wave (or swell) and accommodate the fall of the buoy as it drops into the troughs between waves. Alternatively, or in addition, a set of resistance buckets may be configured to alternately resist the downward force of the buoy as the buoy drops into the troughs between waves and accommodate the upward force of the piston as it is forced upward (relative to the buoy) by the falling of the floating structure into the trough of by each wave.

According to further embodiments, the floating structure of the invention can be tethered to a boat, anchorage float, or a fixed structure (either on shore or in the water), anchored directly to the seabed, or even be allowed to float freely on the ocean. No rigid or permanently fixed structures are required to operate the device.

### BRIEF DESCRIPTION OF DRAWINGS

In the following description, the invention will be further explained in detail with reference to one example for design, assembly, placement and attachment of the electricity generation platform and drive piston in which:

FIG. 1 is a perspective view of a floating mechanical electrical generation platform connected to a buoyancy-controlled piston and an anchorage float according to an embodiment of the invention.

FIG. 2 shows a buoyancy-controlled drive piston with angled resistance buckets according to an embodiment of the invention.

FIG. 3 is a close-up perspective view of a gear rack and pinion gear with anti-reverse bearing according to an embodiment of the invention.

FIG. 4 is a view of a roller sled which attaches to the rotating drive shaft on the electrical generation platform on either side of the pinion gear. This roller sled rides inside a track mounted on a box frame located at the top of the piston and serves to guide the pinion gear in its linear motion along the gear rack.

FIG. 5 is a side view of a gear rack and pinion gear mounted in the box frame with one roller sled pictured just behind the pinion gear and situated to travel along one side of the track.

FIG. 6 is a perspective view of a mechanical electrical generation platform with flywheel, gears and dynamo according to an embodiment of the invention.

FIG. 7 is a view of the rotating drive shaft of the device and is pictured with the various bearings, gears and bearing retainers, but with the support structures hidden for ease of viewing internal parts.

FIG. 8 is a perspective view of the rotating drive shaft and its accompanying gears and its interaction with a second shaft having a flywheel.

Features in the attached drawings are numbered with the following reference numerals:

101 weight
102 ring one
103 ring two
104 ring three
206 support bracket
224 bearing retainer
105 leverage bar four
225 flange bearing
106 angled resistance
207 drive shaft
301 seabed anchor bucket
208 gear one
302 ring four
107 lower compartment
209 shaft two
303 connector chain 1
108 middle
210 gear two
304 connector ring five compartment
211 flywheel
305 anchorage float
109 upper compartment
212 dynamo
306 ring six
110 box frame
213 pinion gear
307 ring seven
111 track
214 anti-reverse bearing
308 ring eight
112 gear rack
215 inner race key
309 connector chain 2
113 air-filled tube
216 outer race key
310 ring nine
114 water-filled tube
217 roller sled
311 ring ten
201 floating structure
218 side roller wheel
312 connector chain three
202 center brace
219 side roller axle
313 ring eleven
203 support bracket one
220 front roller wheel
314 ring twelve
204 support bracket two
221 front roller axle
315 ring thirteen
205 support bracket
222 shaft retainer
316 front brace three
223 rotary bearing

### DETAILED DESCRIPTION OF THE INVENTION

The detailed description which follows shows each of the main sections of the invention responsible for the power generation. It then details the connection of these sections to each other on the floating structure along with their respective connections to the seabed.

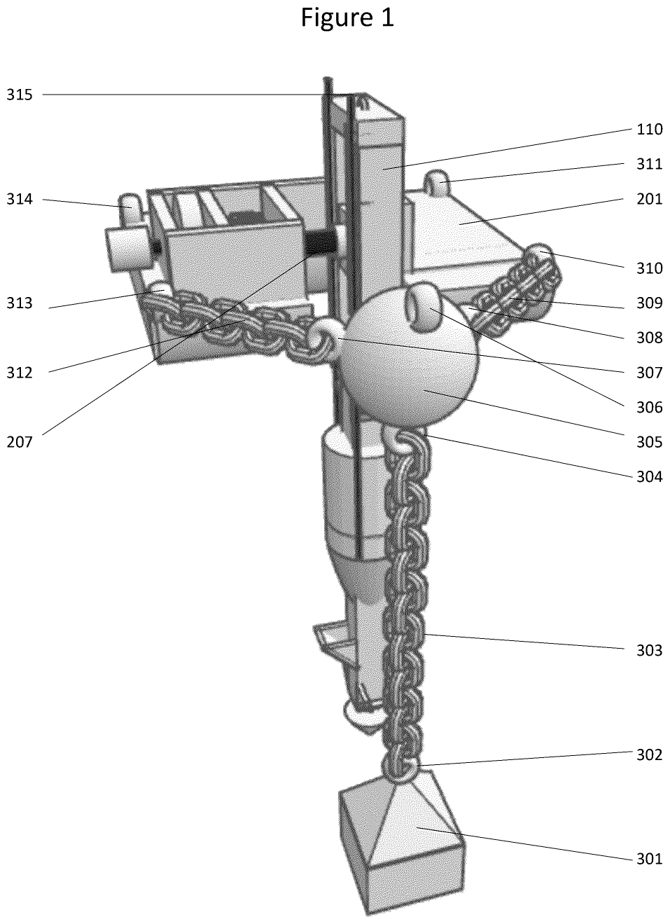

Referring to FIG. 1, an exemplary embodiment of the invention is presented showing a buoyancy-controlled drive piston connected to an electrical generation station mounted on a floating structure. According to a preferred embodiment, the floating structure 201 may have a rectangular-shaped outline with vertical sides and a curved or angled front, but any shape falls within the scope of the invention. The floating structure may feature a cut out large enough to accommodate passage of at least the top portion of the buoyancy-controlled piston. In the case of a rectangular buoy, the cutout is preferably at the front end of the floating structure in order to maximize the effect of the wave action. In the event that the use of the device is expected to be brief and temporary, an inflatable version of the floating structure can be used. Deflation of the floating structure would permit easier storage of the device. The electrical generation platform is preferably attached to the top of the floating structure, but could be housed within the floating structure itself. The piston and platform are connected by a gear rack and pinion gear with anti-reverse bearing or similar device at or near the top of the piston, for example via box frame 110, and rotating drive shaft 207 on the electrical generation platform.

The power generating devices of the invention may be deployed individually, or as part of a connected series or array. They can be tethered to a boat, anchorage float, or a fixed structure (either on shore or in the water), anchored directly to the seabed, or even be allowed to float freely on the ocean. No rigid or permanently fixed structures are required to operate the device. Rings 310, 311, 313 and 314 may be provided for use in the deployment of the floating structure from service vessels, or to allow the floating structure to be connected by tethers 309 and 312 to, for example, an adjacent floating structure or an anchorage float 305 which is anchored on the seabed. This feature of the invention allows the deployment of a series of floating structures to be a relatively quick process in which the floating structures can either be moved from time-to-time or remain in place indefinitely, without any significant environmental impact. In the event that a permanent placement is intended, the anchor 301 to the seabed can be made into an artificial reef by placing shellfish spat, coral or plant seedlings onto the anchoring system. Having been placed on the sea bed, the anchor can be tethered by means of ring four 302, connector chain one 303 and ring five 304 to the anchorage float 305. The anchorage float, in turn is connected to the floating structure by means of ring eight 308 with connector chain two 309 on one side and ring seven 307 with connector chain three 312 on the other side. For ease of deployment, retrieval or tethering to a vessel, land-based connection, etc., the anchorage float is equipped with an additional tethering/towing ring, ring six 306.

The drive piston extends from the box frame 110, down through the opening of the floating structure and into the water. As described in more detail below, the drive piston is configured to maintain neutral buoyancy and to resist the upward motion of the floating structure portion of the device as the floating structure rises with each passing wave, driving the gear rack downward each time the floating structure rises on the wave. As the floating structure falls into each trough between waves, the drive piston maintains a vertical orientation and relative position in the water, allowing the pinion gear to return to its original position on the gear rack. Since the piston is located slightly toward the front of the floating structure, it is possible that the travelling length of the box frame (which houses the rack and pinion) may slightly exceed wave height.

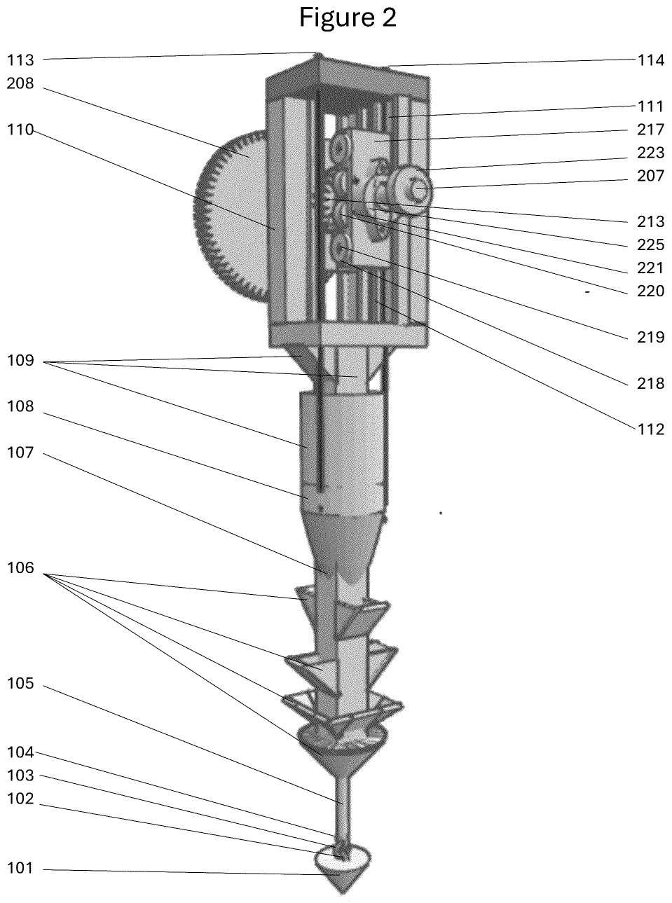

The details of the drive piston are explained in more detail with reference to FIGS. 2-5.

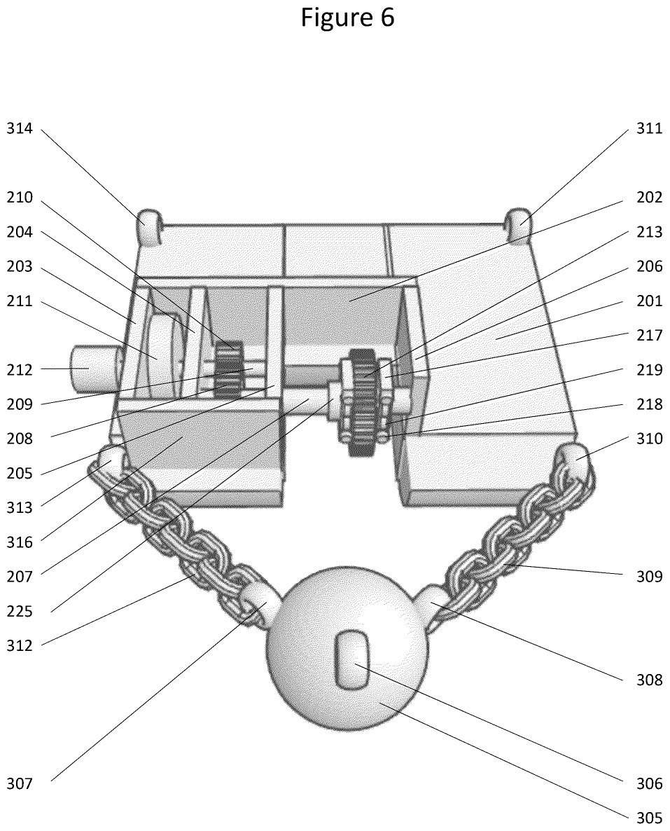

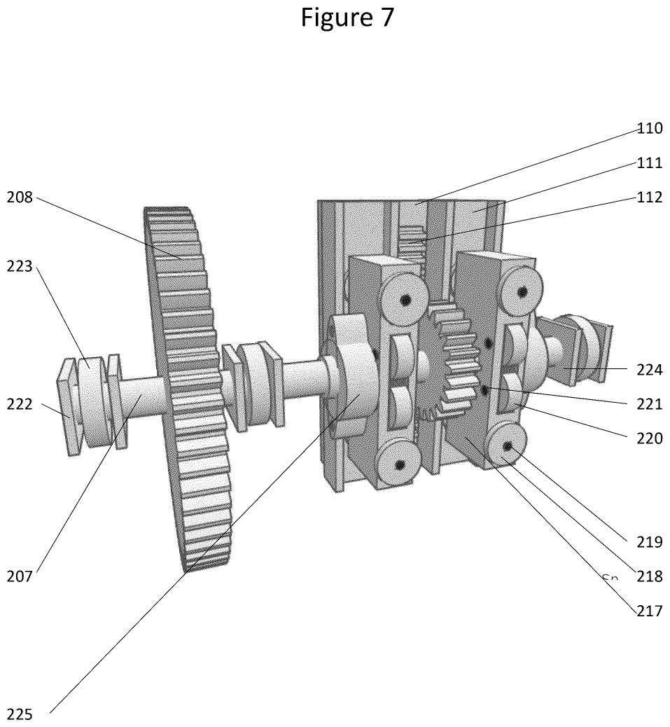

The power generation of the device, explained in more detail with reference to FIGS. 6 and 7, may be configured to transmit electricity to land or ocean based electrical devices, structures or vessels using well-known methods and structures.

Turning to FIG. 2, the details of one non-limiting embodiment of the drive piston are explained.

The main body of the piston has a plurality of compartments. A first lower compartment 107 is configured to be filled entirely with water. Being filled with water, it is more neutrally buoyant than the concrete filled cone-shaped weight 101, allowing this lower section of the piston to remain generally static in the water column.

A second (middle) compartment of the piston 108 is configured to permit addition or removal of water, thereby allowing a user to adjust the buoyancy of the piston as required. Water may be added to or removed from the second (middle) compartment through tubes 113, 114 which are open to the air, preferably above an estimated maximum water line. If greater buoyancy is desired, air can be added to the middle chamber through one tube 113. If less buoyancy is called for, the middle chamber can be filled with water via the other tube 114.

A third (upper) compartment 109 is filled with air, gas, or other buoyant material. The third compartment may roughly assume the form of an hourglass, with a tapered and narrowed central section. The top section of the third compartment provides buoyancy to keep the piston afloat but is tapered down to promote entry into the water when submerging. The middle section of the piston's third (upper) compartment is preferably narrower and provides slightly less buoyancy. This allows the piston to partially submerge as a wave crest passes above, but allows the piston to return to the surface as the trough of the wave passes. The lowest portion of the third compartment is tapered at the bottom to allow the piston to easily move lower in the water column but has a flattened top rim to help impede the rising of the piston. While a rigid construction of the three compartments is recommended for greater longevity, flexible or collapsible materials may be used for short-term use, thus making the device easier to store.

As discussed above, the gear rack 112 which drives the pinion gear 213 is shown as housed inside a box frame 110 at the top of the piston, although any type of housing or supporting structure may be used. Atop the box frame is a ring 315 which can be used to deploy and retrieve the piston. Connection of the rack to the pinion is made in a manner which ensures the free motion of the pinion gear as it intermeshes with the gear rack within the box frame. This is accomplished through the use of two roller sleds 217. Each roller sled is attached to the drive shaft 207 with a flange bearing 225 on the outer side of the roller sled (the pinion gear being on the inside). On each side of the roller sled are side roller wheels 218 which ride on a side roller axle 219. Each sled also has front roller wheels 220 which ride on a front roller axle 221. These wheels guide each roller sled as it rides along a track 111 in liner motion. The track is affixed to the box frame. The purpose of the roller sleds 217 is to maintain a constant and even distance between the gear rack 112 and the pinion gear 213 so that the teeth of the gear rack and the teeth on the pinion gear are smoothly enmeshed. As a wave crest passes, it lifts the buoy, but the piston resists the upward force of the rising buoy, the piston becoming partially, mostly, or entirely submerged as the wave passes. With the differential motion between the rising floating structure and the resisting piston, the gear rack, in the box frame, moves smoothly downward causing the pinion gear to rotate. The pinion gear, in turn initiates the rotation of the drive shaft because it is connected to the drive shaft with a clutch-type bearing that has an anti-reverse bearing or similar device, gripping the drive shaft and causing it to rotate as the box frame and gear rack move downward. The inner ring of this anti-reverse bearing connects to the shaft via an inner race key 215. The outer ring of the anti-reverse bearing is connected to the pinion gear via outer race key 216. The pinion is guided along the length of the gear rack in the box frame by the roller sleds which travel along their respective tracks. As the crest of the wave passes, the floating structure drops into the trough, the buoyant piston returns to the surface, and gear rack 112 travels upward riding along the pinion gear. During this upstroke motion, the pinion spins freely on the drive shaft due to the ratchet-type motion of the anti-reverse bearing. The length of the box frame and gear rack can vary to adjust for anticipated wave height and intensity.

A plurality of angled resistance buckets 106 may be mounted on the side of the piston, well below the waterline. Any type of resistance structure may be used according to the invention and the exemplary structures described herein should not be considered limiting. Referring to the exemplary resistance structures described herein, the angle of the buckets may be roughly between 0° and 60° from horizontal, preferably between 0° and 45° from horizontal, and more preferably 0°-30° from horizontal. Due to their angle, the buckets resist upward motion, but readily allow downward motion. For longevity, these buckets can be made of rigid material. Alternately, the buckets can be made of flexible material thus increasing the power of the stroke of the piston due to the fact that the upward motion of the piston would more fully expand the material while the downward motion of the piston would cause the flexible sides of the buckets to compress against the piston, allowing it to fall even faster and return its original position in the water column more rapidly. The use of flexible material for the buckets additionally allows for ease of storage when not in use. When the floating structure begins to rise on a wave and attempts to bring the piston with it, via the rack and pinion, the resistance buckets engage and impede upward motion of the piston, causing it to remain relatively stationary in the water column. As the floating structure 201, continues to rise on a wave, the resistance provided by the resistance buckets causes the piston to move downward relative to the buoy. As a point of fact and to be precise, the piston remains relatively stationary while the floating structure is moving upward on the wave. In turn, the gear rack 112 on the piston is forced downward. This downward motion of the gear rack results in an energy producing power stroke of the gear rack along the pinion gear to provide torque to rotate the drive shaft 207 and spin the flywheel 211.

As the crest of each wave passes and the floating structure enters the trough between waves, the piston will move slightly downward in the water column. As the piston moves downward, the angled design of the resistance buckets reduce resistance to the surrounding water, allowing the piston to return to/maintain its place lower in the water column in preparation for the next wave crest.

Weighted body 101 may be connected to the bottom of the piston and may take any form and may be weighted in any fashion. FIG. 2 shows a conical body containing or made from concrete, but any weighted body will suffice. The weighted body may be integral with or connected to the main body. In the case that the weighted body is not integrally formed, but merely connected, weighted body may be connected to main body by any conventional means. FIG. 1, by way of example only, shows a conical container filled with concrete. A ring 102 is fixed to the top of the weighted body. It is joined with a connector ring 103 to a fixed ring 104 on the bottom of a leverage bar 105. This leverage bar connects to the main body of the piston to provide leverage for the weighted body without adding excess weight to the overall piston. The leverage bar, in conjunction with the weighted body, serves to hold the piston in an upright vertical position and provides weight to pull the gear rack along the pinion gear.

As outlined above, when a wave crest passes, the floating structure above moves upward, the piston below, attached via the gear rack and pinion gear remains nearly stationary, thus causing the rack to move in a downward power stroke.

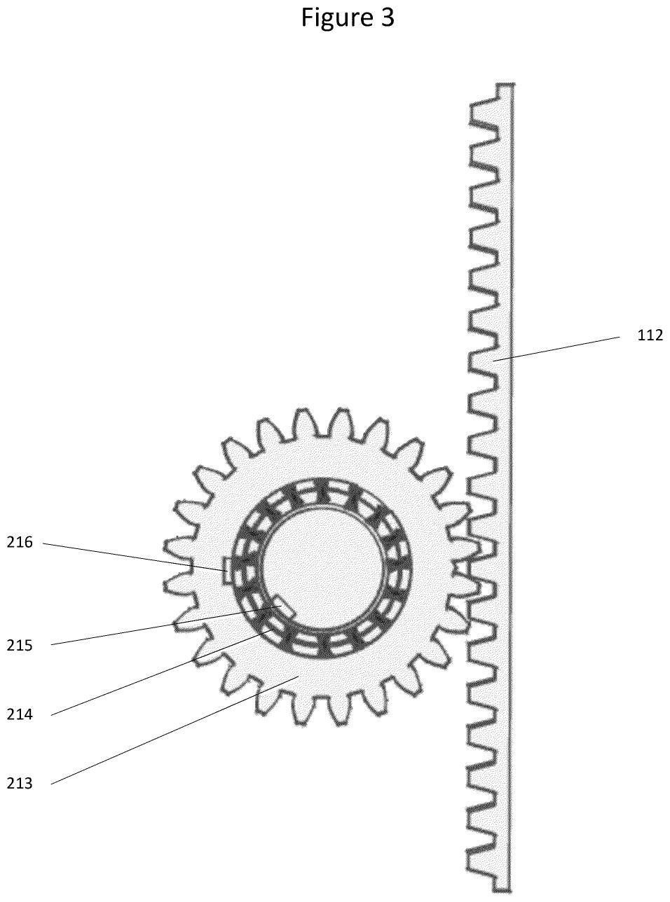

FIG. 3 is a close-up view of the rack and pinion. The teeth of the rack and the teeth of the pinion gear can be seen to intermesh. In the center of the pinion gear can be seen an anti-reverse bearing 214 designed to initiate rotation of the drive shaft during the downstroke of the piston, but spin freely around the shaft during the upstroke phase of the motion of the piston. Connecting the inner race of the anti-rotation bearing to the drive shaft is an inner race key 215. Connecting the outer race of the anti-reverse device/bearing to the pinion gear is the outer race key 216. During the downstroke of the piston, considerable pressure is put on the inner race key as it applies rotational pressure on the drive shaft. During the upstroke of the piston, as the pinion gear returns to its original location near the top of the gear rack, minimal pressure is put on the outer race key as the pinion gear is allowed to spin freely around the drive shaft.

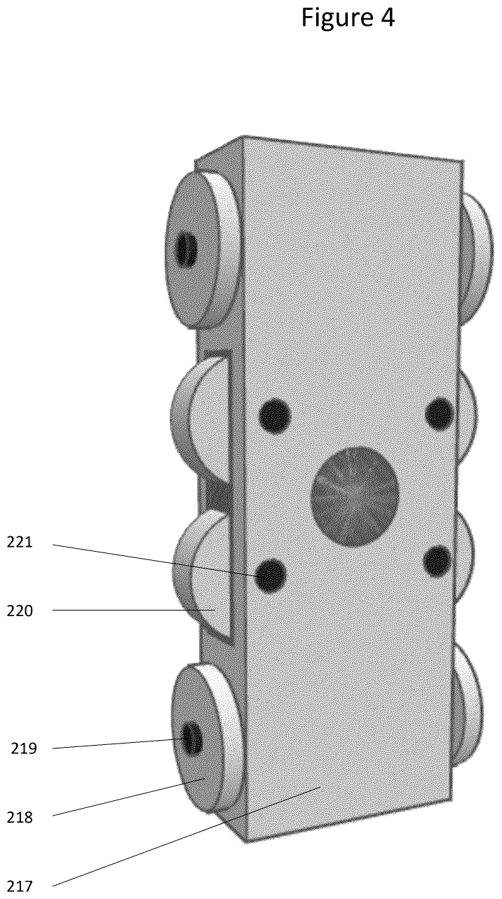

FIG. 4 is a close-up view of the roller sled, The roller sled 217 is equipped with pairs of rollers on two sides. Side roller wheel 218 causes the sled to follow the sides of a track which is mounted on the box frame at the top of the piston. The side roller wheel is attached to the block of the roller sled with a side roller axle 219. Front roller wheel 220, causes the roller sled to follow the track by riding along the face of the track. The front roller wheel is attached to the roller sled block with a front roller axle 221.

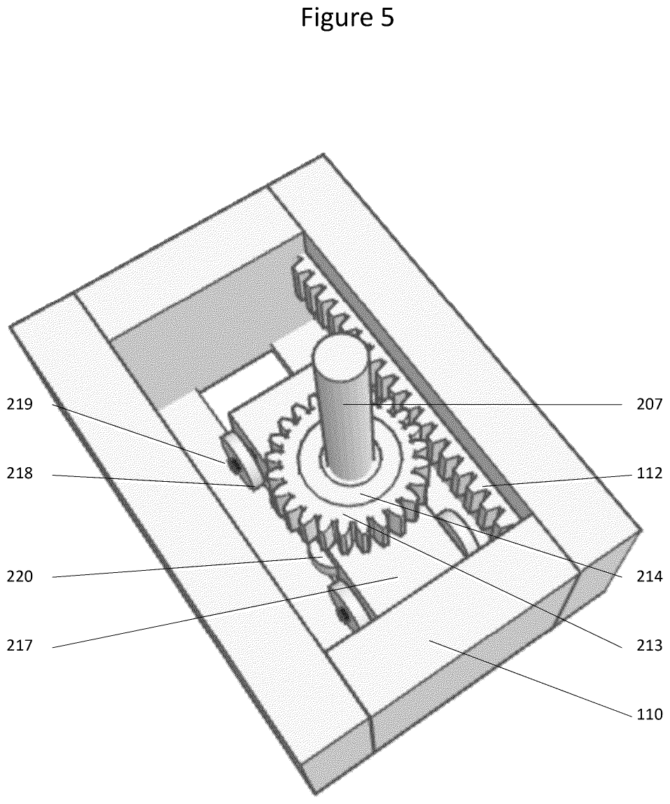

FIG. 5 is a close-up side view of the gear rack intermeshed with the pinion gear and attached to the box frame. A roller sled is shown in position to roll along the track on the box frame. When the floating structure reaches the crest of a wave, the power stroke is completed. The piston 107 begins to move slightly downward to regain any slight upward rise of the piston caused by the power stroke.

Turning to FIGS. 6 and 7, a particular but non-limiting embodiment of the electricity generating station of the invention will be described, but it will be recognized by the person of ordinary skill that any construction or arrangement of devices that generate electricity from rotation of a shaft is well within their skill and is contemplated to fall within the scope of the invention.

The electricity generating station embodiment shown in FIGS. 6 and 7 features a base and a plurality of supports. The supports hold the bearings which allow for the rotation of the metal shafts.

Pinion gear 213 is attached to drive shaft 207. The junction of the pinion gear and the shaft 207 has an anti-reverse bearing 214, which applies rotational force to the shaft with every downstroke of the piston, but allows the piston gear to spin freely as it returns to is original position on the gear rack during the upstroke.

Referring now to FIG. 7, drive shaft 207 runs from support bracket two 204, through support bracket three 205 and then to support bracket four 206. Mounted to the drive shaft 207 are rotary bearing 223, flange bearing 225 (which holds the roller sled 217 to the shaft), an anti-reverse bearing 214 which connects the pinion gear 213 to the drive shaft 207, a second flange bearing with roller sled, another rotary bearing, a large spur gear 208 and a final rotary bearing. The shaft is held in place at either end by a shaft retainer 222. Rotary bearings are held in place by a bearing retainer 224.

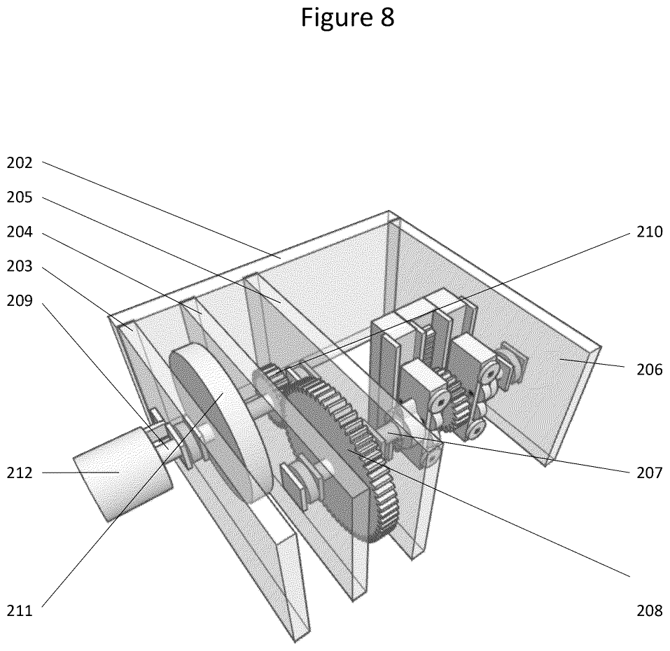

Referring to FIG. 8, second shaft 209 runs from support bracket one 203, through support bracket two 204 and then to support bracket three 205. Mounted to second shaft 209 is spur gear 210 whose motion is driven by drive shaft 207 via spur gear 208. Also mounted to second shaft 209 is a flywheel 211. Flywheel 211 causes the energy from the gear rack and pinion gear to be stored in the rotational momentum of the flywheel and passed to the dynamo 212. This dynamo is responsible for the generation of the electric power. The support brackets are attached to center brace 202 and front brace 316.

While it is possible to generate electricity through use of a dynamo with permanent magnets, the use of electromagnets is recommended as a safety feature so that if the generation floating structure should break free from its mooring or electrical connection it will stop producing electricity, preventing the release of unregulated electricity into the water. In the event that a series of buoys are installed in close proximity to each other, a single initiator floating structure with permanent magnets might possibly be used to initiate the power for the electromagnets in the other buoys in the series, thus making the system self-sufficient, without need of connection to electrical storage devices or the electrical grid. This is provided that all caution and care is exercised in the anchoring and tethering of the initial permanent magnet buoy.

1. A device for converting oceanic wave energy into rotational energy for the production of electricity, comprising:
a floating structure configured to rise and fall with each passing wave crest and wave trough, respectively;
an electricity-generating dynamo mounted on said floating structure;
a drive piston resting substantially beneath a water surface and configured to resist upward motion with each said passing wave crest;
said drive piston comprising a rack and pinion gear system coupled to a drive shaft and configured to unidirectionally rotate said drive shaft as a relative position between said drive piston and said floating structure changes, said drive shaft coupled to a power transmission mounted on said floating buoy, said power transmission configured to transmit rotation of said drive shaft to said electricity-generating dynamo.

2. A device according to claim 1, further comprising resistance buckets mounted to said drive piston to apply resistance to the force of oceanic waves acting on said piston.

3. A device according to claim 1, wherein upward motion of said floating structure on each said passing wave crest relative to said drive piston causes said drive shaft to move upward relative to said drive piston causing said drive shaft to rotate in said rack and pinion gear system.

4. A device according to claim 1, wherein said rack and pinion gear system is coupled to said drive shaft via an anti-reverse bearing device configured to translate a vertical up and down motion of said rack and pinion gear system into rotational movement of a drive shaft.

5. A device according to claim 1, wherein said power transmission comprises a plurality of intermeshed gears to transmit rotational movement of said drive shaft to a spinning flywheel.

6. A device according to claim 1, wherein said power transmission comprises a plurality of gears to transmit rotational movement of said drive shaft to turn a dynamo shaft of said electricity-generating dynamo.
